(19) United States
(12) Patent Application Publication
(10) Pub. No.: US 2010/0138816 A1
(43) Pub. Date: Jun. 3, 2010

(54) MULTIMEDIA SERVICE COMPOSITION FACTORY

(75) Inventors: Walid Mokrani, Montreal (CA); Yves Lemieux, Kirkland (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET L M ERICSSON (PUBL), Stockholm (SE)

(21) Appl. No.: 12/369,862

(22) Filed: Feb. 12, 2009

Related U.S. Application Data
(60) Provisional application No. 61/118,530, filed on Nov. 28, 2008.

(51) Int. Cl. G06F 9/45

(52) U.S. Cl. 717/143

(57) ABSTRACT

Systems and methods for the creation and deployment of services on a converged network are described herein. These services can be initially created from visual constructs and have their life cycle performed and monitored by a multimedia service composition factory. Functions for design, implementation, installation, verification and coordination can be provided to compose services after pre-compiled code segments are received from a user interface.

### RELATED APPLICATION

The present application is related to, and claims priority from, the U.S. Provisional Patent Application Ser. No. 61/118,530, entitled “Multimedia Service Composition Factory in NGI”, and filed on Nov. 28, 2008, the disclosure of which is incorporated herein by reference.

### TECHNICAL FIELD

The present invention relates generally to communications and in particular to methods, devices and systems for the composition of services in communications systems.

### BACKGROUND

Communication systems continue to grow and evolve. Convergence between different types of communication systems, e.g., Internet Protocol (IP), connection-based voice communications, and the like, is advancing rapidly. Recently the phrase “Next Generation Network” (NGN) has been used to describe various activities associated with this evolution. As defined by the International Telecommunications Union (ITU), an NGN is a packet-based network able to provide services (including telecommunication services) and able to make use of multiple broadband, QoS-enabled transport technologies, in which service-related functions are independent from underlying transport-related technologies. NGNs will also likely offer unrestricted access by users to different service providers and will support generalized mobility, which in turn will provide for consistent service provision to end users. It is expected that these NGNs (or converged networks) will be able to provide more enriched and seamless multimedia services as well as bringing both new and existing services to the large mobile network market.

Various mechanisms for composing services for networks have been proposed including, signaling based solutions, web service solutions and multi-protocol architectures. Each of these types of service creation methods has its own benefits and drawbacks, in its area of service creation. However, in the realm of converged networks it is expected to be desirable to have service composition architectures designed for the challenges associated with converged networks, e.g., service composition techniques and methods which provide a rapid time to market for the composed service.

Accordingly, systems and methods for the creation and deployment of services on a converged network which address these, and other, issues are desirable.

### SUMMARY

According to an exemplary embodiment a method for composing a service includes: receiving, at a coordinator function, at least one pre-compiled code segment, wherein the at least one pre-compiled code segment describes the service; modifying and validating, at a design function, the at least one pre-compiled code segment, wherein the validating includes checking for syntax errors; generating additional code associated with the service and compiling both of the at least one validated pre-compiled code segment and the additional code, wherein the step of compiling results in a deployable service; and deploying the service, wherein the service is usable by at least one subscriber.

According to another exemplary embodiment a method for composing a service includes: receiving at least one pre-compiled code segment associated with the service; forwarding the at least one pre-compiled code segment toward a service design function; receiving a modified version of the at least one pre-compiled code segment from the service design function; forwarding the modified version of the at least one pre-compiled code segment toward a service implementer; receiving a compiled version of the modified version of the at least one pre-compiled code segment from the service implementer; and deploying the compiled version as the service.

According to still another exemplary embodiment a communications node for coordinating composition of a service includes: a processor; a memory; and a communications interface which performs the steps of: receiving at least one pre-compiled code segment associated with the service; forwarding the at least one pre-compiled code segment toward a service design function; receiving a modified version of the at least one pre-compiled code segment from the service design function; forwarding the modified version of the at least one pre-compiled code segment toward a service implementer; receiving a compiled version of the modified version of the at least one pre-compiled code segment from the service implementer; and deploying the compiled version as the service.

### BRIEF DESCRIPTION OF THE DRAWINGS

The accompanying drawings illustrate exemplary embodiments, wherein:

FIG. 1 depicts a relationship between converged networks, other networks and connections thereto according to exemplary embodiments;

FIG. 2 illustrates a multimedia service composition factory (MSCF) according to exemplary embodiments;

FIG. 3 shows a graphical user interface (GUI) with visual code constructs according to exemplary embodiments;

FIG. 4 depicts a composed service according to exemplary embodiments;

FIG. 5 shows another composed service according to exemplary embodiments;

FIG. 6 depicts a communications node according to exemplary embodiments;

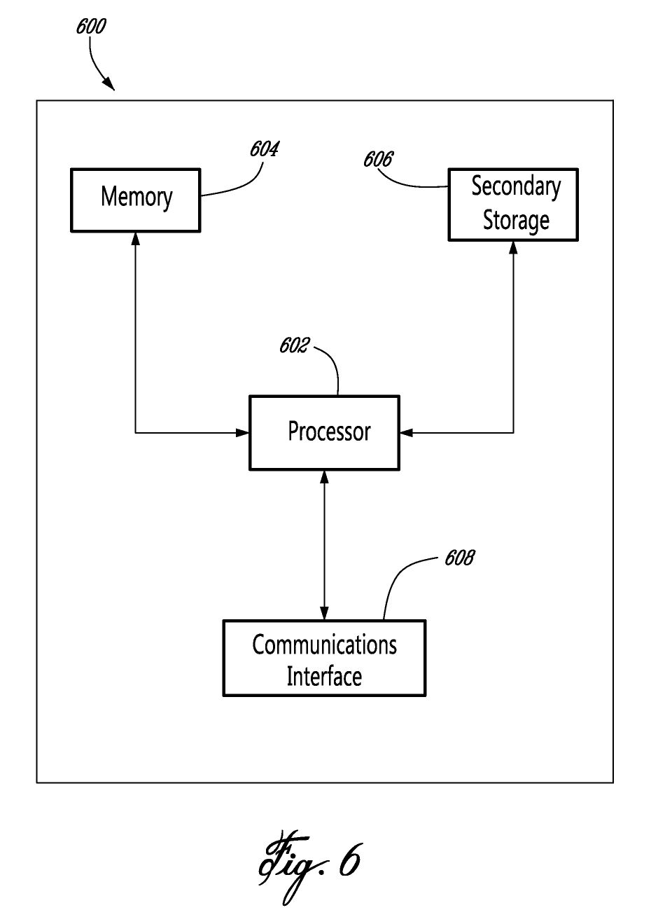

FIG. 7 is a method flowchart for composing a service according to exemplary embodiments; and

FIG. 8 shows another method flowchart for composing a service according to exemplary embodiments.

### DETAILED DESCRIPTION

The following detailed description of the exemplary embodiments refers to the accompanying drawings. The same reference numbers in different drawings identify the same or similar elements. Also, the following detailed description does not limit the invention. Instead, the scope of the invention is defined by the appended claims.

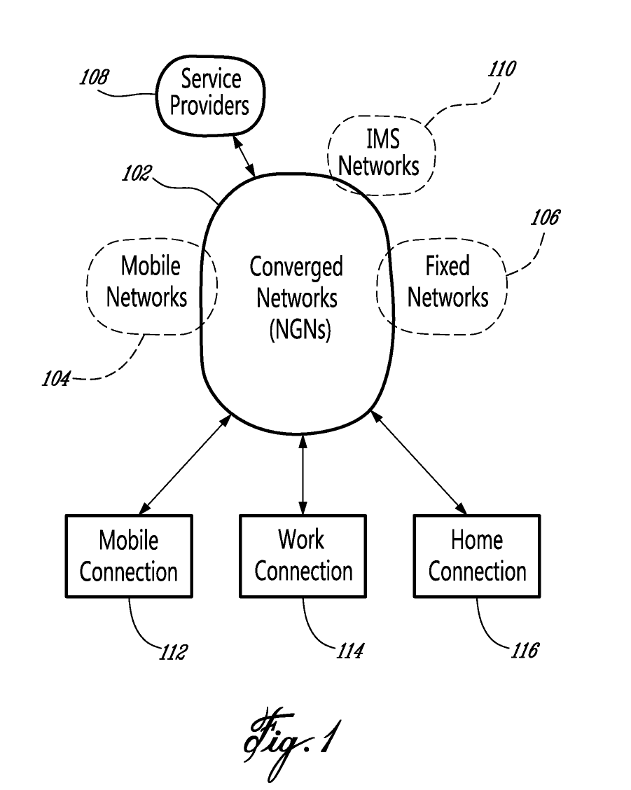

Convergence between different types of communication systems is occurring at various speeds in different geographic areas. It is expected that users of these “converged” networks (also sometimes described as “next generation networks” (NGNs)) will desire quick, efficient creation and deployment of services which are designed for use in this converged network environment, but which are also potentially usable in other environments. Prior to discussing the exemplary embodiments below, a purely illustrative overview of a converged network will now be described with respect to FIG. 1 to provide some context for this discussion.

As improvements are made with respect to communications technologies and infrastructures, it is expected for converged networks (or NGNs) to become more common. An exemplary overview of a converged network 102 is shown in FIG. 1. As mobile networks 104 and fixed networks 106 converge, a converged network 102 is expected to emerge. This converged network 102 can, for example, act as a uniform network where telephony entities can directly exchange messages with Internet web services. Among other things, this allows users to, in some cases, avoid gateways that can hide telephony events (such as call progress) to allow for more direct user experiences. Converged networks 102 could interact with Internet Protocol Multimedia Subsystem (IMS) networks 110 (or directly have some or all of the capabilities of an IMS network 110) as well as various other service providers 108 and legacy networks/architectures (not shown). Additionally, it is expected that various end users will have access to the converged network 102 (either directly or through their access provider) through various devices in a plurality of locations, such as, their mobile connection 112, a work connection 114 as well as a home connection 116. These end user devices could include cell phones, personal computers, personal digital assistants, set-top boxes and the like.

Exemplary embodiments described below can be used to both create and deploy services for use in converged networks 102 (or other networks) as well as to improve the process of creating these services. Implementation of the below described exemplary embodiments can result in a reduced time to market for these services, provide a unified orchestration of these services through the use of a coordinator function (or a similar function) and allow the repeated re-use of code blocks to support these services.

According to exemplary embodiments, the composition life cycle for services for networks, e.g., converged network 102, can include the following phases: design, implementation, deployment, activation, execution, upgrade and retirement. Additionally, according to exemplary embodiments, this service composition life cycle can generally be automated through the use of a multimedia service composition factory (MSCF) which typically consists of a set of coordinated services that perform the various life cycle portions as desired.

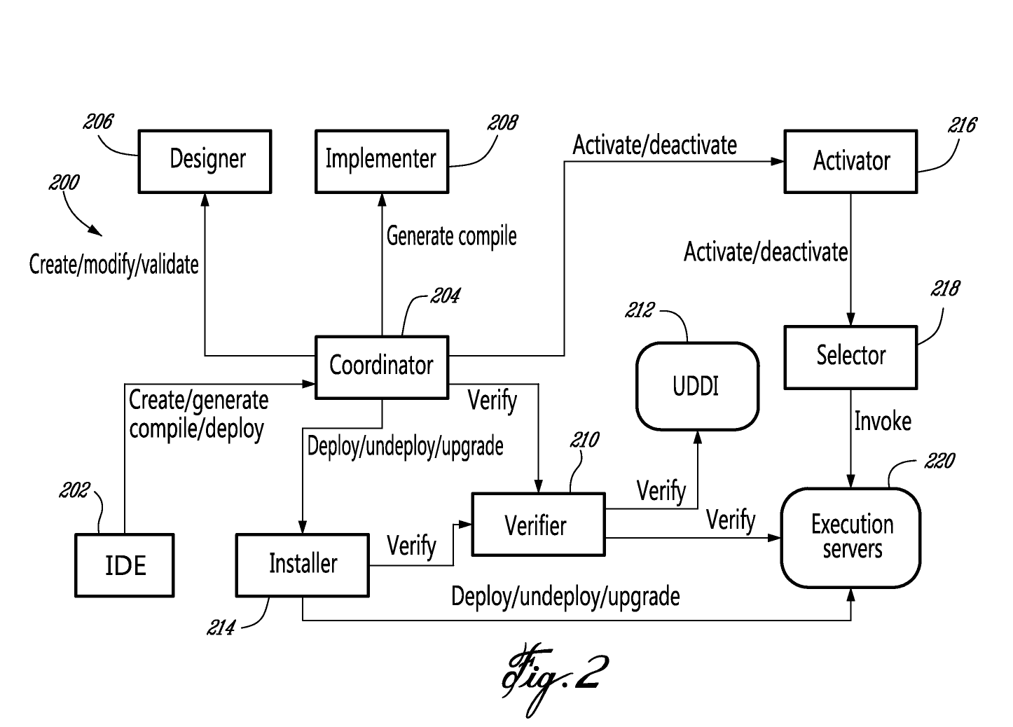

According to exemplary embodiments, service composition can be relatively simple and quick to perform, through the use of a visual composition language which can allow programmers and non-programmers to design new composed services, by assembling graphical constructs to describe composed service interfaces. These composed services can be automatically generated and implemented as services which allow for the reuse of both previously composed services and parts of previously composed services which can then be used to make new composed services. These composed services can be deployed over the Internet as well as other networks. This automatic generation and reuse of composed services also avoids creation of a new service execution environment, i.e., there typically will be no need for new deployments of the service execution environment. An exemplary system for implementing the service composition life cycle for services for networks according to exemplary embodiments is shown below with respect to FIG. 2.

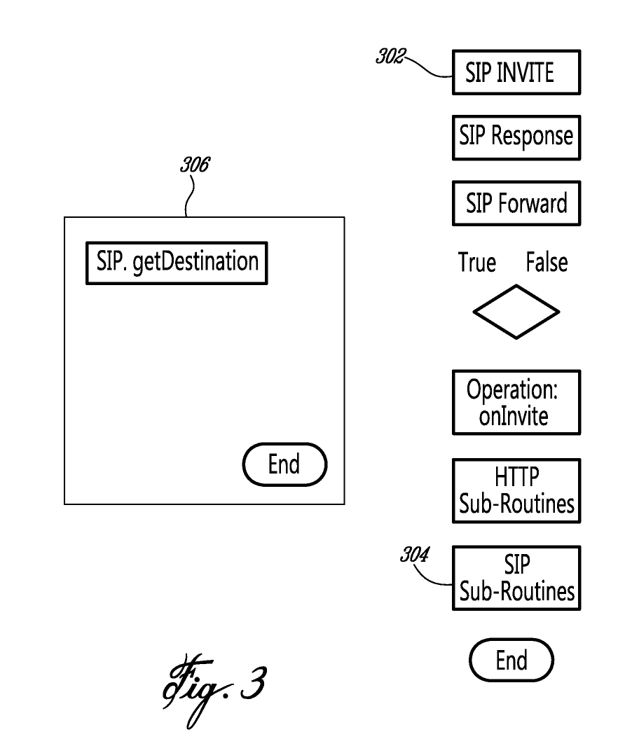

Therein, a multimedia service composition factory 200 includes constituent functions, logic, modules and nodes for implementing the service composition life cycle according to these exemplary embodiments. Initially an operator interacts with an Integrated Development Environment (IDE) 202, which can include a graphical user interface (GUI) for selecting and relating visual code constructs (some of which can be pre-defined) to one another, a library of previously compiled code fragments to be used as basic constructs, the platform used for compiling the aggregated constructs, the interpreter to analyze the high level language used in handling these basic constructs, and a wizard for tracking progress of a composed service through the multimedia service composition factory and for interacting with received feedback, if needed, as the composed service is generated by the multimedia service composition factory. These visual code constructs can include tests, loops, parallel processing, operation calls and the like, and can be included in an initially deployed IDE 202. These visual code constructs will typically be designed as plug-ins that allow sharing, reuse and future extension of the visual language. Additionally, basic and composite multimedia services can be manipulated by the IDE 202, e.g., discovery, composition, implementation, etc. In this context, the IDE 202 can be generally considered to include elements displayed on the screen as well as the supporting logic for processing user entered elements and their results, e.g., the tracking wizard, compiling code constructs and the like. According to one exemplary embodiment, these code constructs as displayed by the IDE 202 and shown in FIG. 3, can be commands, e.g., SIP INVITE 302, or previously generated groupings of code, e.g., SIP Sub-Routines 304.

As described above, a library of code constructs can be a part of the IDE 202. According to other exemplary embodiment, the code constructs and code fragments are templates that are shared, either in a central storage location (not shown in FIG. 2) or downloaded from various servers. Companies can implement, for example, security policies, provisioning and activation policies by publishing their templates in such a manner that their templates typically need to be used by third party products (3PP) and/or internal service development units. Additionally, the MSCF 200 can have a coordinator 204 support multiple IDEs 202 as desired.

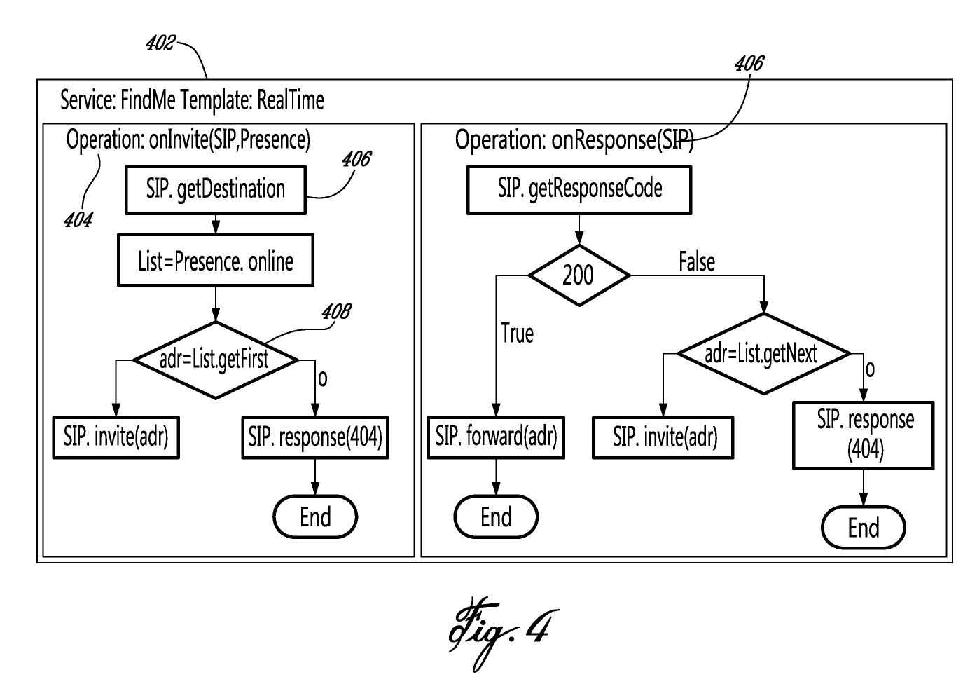

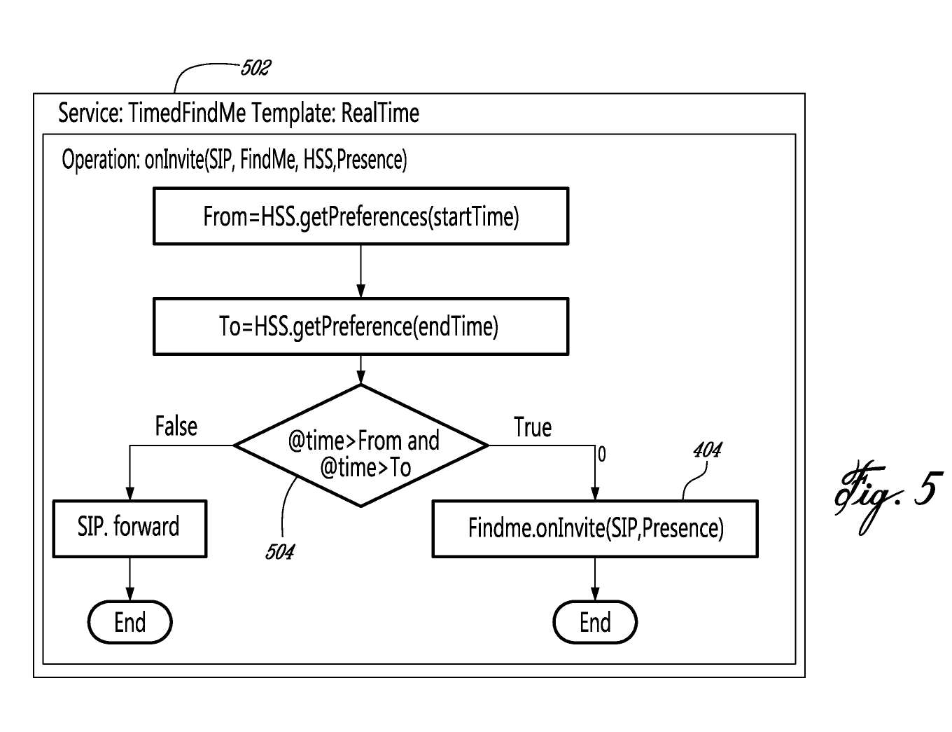

To start a new service composition according to these exemplary embodiments, the desired visual code constructs can be dragged, i.e., by placing a cursor (not shown) over one of the constructs, depressing a mouse button and moving the cursor along with the selected visual construct to the desired location in the work area and releasing the mouse button, into a work area 306 on the IDE 202 which can be used to make new service compositions. When all of the desired visual constructs have been dragged to the work area 306, and linked together using logical links (described below), a user can indicate to the IDE 202 that the newly created service is ready for further processing, e.g., by pressing a “Done” button on the IDE 202 (not shown). Then, for example one or more code segments in an eXtensible Markup Language (XML) format can be generated by performing a pre-compiling function prior to transmitting the service composition to the coordinator function 204. Specific examples of services which are initially composed using such a IDE 202 will be described in more detail below with respect to FIGS. 4 and 5.

According to exemplary embodiments, the coordinator function 204 ensures that the steps used in the service composition life cycle are handled by the relevant components of the MSCF 200, e.g., the IDE 202, the designer function 206, the implementer function 208, the verifier function 210, the activator function 216 and the installer function 214, in a timely and synchronized fashion. According to another exemplary embodiment, some of these various components shown as separate entities within the MSCF 200 can be combined as desired with IDE 200 as a single entity, e.g., the previously described IDE 202, the coordinator function 204, the designer function 206 and the implementer function 208.

After receiving pre-compiled code segments associated with a new service to be composed from the IDE 202, the coordinator function 204 sends those pre-compiled code segments to the designer function 206. The designer function 206 receives the service composition from the coordinator function 204 and checks the service composition for syntax. Additional various visual code constructs for use by the IDE 202 can be created by the designer function and transmitted back to the IDE 202 via the coordinator function 204. Also, the designer function 206 can take received service compositions and improve or modify them as desired. After completion of its review of the received service composition, the designer function 206 returns the service composition to the coordinator function 204.

The coordinator function 204 then sends the service composition to the implementer function 208 which takes the received service composition and generates code, e.g., Java, C++ or the like, and re-compiles the service composition for future execution on a physical communication node, e.g., execution server 220. More specifically, the implementer function 208 includes a generator sub-function that takes as input the service description, the templates and produces source code in a given language which is then compiled and packaged. Additionally, the implementer function 208 according to this exemplary embodiment performs a verification procedure on the compiled code to ensure that the compiled code for this new service is not in conflict with other code associated with previously created services, e.g., to remove or reduce the possibility of compiling failure due to linked code issues from various code libraries. After re-compiling the service composition, the service composition is sent back to the coordinator function 204.

The coordinator function 204 takes the compiled code received from the implementer function 208 and then transmits the new service composition to the verifier function 210 and the installer function 214. Before deploying the composed service, the installer function 214 requests the verifier function 210 to ensure that all of the services to be called by the new service being composed actually exist. The verifier function 210 is in communications with a database, e.g., Universal Description, Discovery and Integration (UDDI) registry 212, which maintains dependencies to avoid undeploying or replacing a composed service (or a portion of one) that is referenced by other services. Additionally, the verifier function 210 consults the UDDI registry 212 to ensure that the name used for the composed service is not currently being used by another composed service. In other words, the verifier 210 looks for, and resolves (where possible), external conflicts for the newly composed service. If a conflict is found that the verifier 210 cannot resolve, feedback is initially sent to the coordinator 204 so that the coordinator 204 can create coordination logs on different service composition(s) prior to sending the feedback (plus coordination logs as desired) on to the user through the IDE 202. These coordination logs can include context help provided by the coordinator as it interrogates the IDE 202. According to an alternative embodiment, the coordinator function 204 can be stateless, in which case the coordinator function would forward the conflict information directly to the IDE 202.

Upon receiving a positive response that the composed service has been verified and is ready for deployment, the installer function 214 can then deploy the newly composed service to an execution server (or servers) 220 for future execution and notify the verifier function 210 to update the dependencies in the UDDI registry 212 (or other appropriate database(s)). In the case where the composed service is an upgrade to an existing composed service, the installer 214 may inform the appropriate physical communication node(s) that new sessions should use the new code associated with the composed service. Additionally, the installer function 214 can monitor the physical communication node(s) so that older versions of the service composition may be removed from service when all sessions using the older version are terminated.

Once the composed service has been deployed by the installer function 214, the coordinator function 204 can notify the activator function 216 that the deployed composed service is ready for activation. The activation function 216 can then activate the deployed composed service for all subscribers or a desired subset of subscribers. For example, the newly deployed composed service could be activated for a group of test subscribers to verify that the composed service works as intended in the production environment. The activation function 216 then notifies the selection function 218, which in turn notifies the execution server(s) 220, of the composed service to activate. The activation request is sent from the activation function 216, and can be translated from the protocol used by the activation function, e.g., session initiation protocol (SIP) or hyper-text transfer protocol (HTTP), into another protocol, e.g., simple object action protocol (SOAP), under control of the selection function 218 for invoking the desired composed service from among the set of composed services located on or accessible by the desired execution server(s) 220. Additionally, according to one exemplary embodiment, the activator function 216 and the selector function 218 can be collocated with the execution server 220.

As described above, code constructs can be used at the IDE 202 for creating composed services. According to exemplary embodiments, the architecture used for creating composed services can be described as a hybrid approach which can automatically generate and compile code at the IDE 202 prior to sending the composed service to the coordinator 204. The visual language(s) used can include a set of graphical constructs, e.g., loops and tests, as well as macros that correspond to fragment code templates. This allows for the reuse of previously created code as well as the generation of new customized code for creating a composed service.

According to exemplary embodiments, a composed service can be based on visual constructs which describe one or more operations as shown in FIG. 4. FIG. 4 shows a composed service Findme 402, which has a Realtime template, and includes two operations, operation onInvite 404 and operation onResponse 406. The Findme service 402 can, for example, enable a user to find other users within converged networks 102. The Realtime template describes that the generator, a sub-function of the implementer 208, can use timers associated with each operation to support (or satisfy) certain quality of service (QoS) thresholds associated with using the composed service Findme 402, e.g., timers are generated at the beginning and the end of each operation of the service that will ensure the operation execution does not exceed a given time period. Operation onInvite 404 handles SIP INVITE messages and operation onResponse 406 handles the corresponding responses. Each service operation can be initially designed as a sequence of visual code constructs (blocks) linked together by logical links, e.g., values or Boolean based flow arrows. Additionally three constructions are used in the service composition Findme 402 as follows: (1) invoke operations, (2) logic test and (3) an End instruction for releasing temporary variables.

As shown in FIG. 4, rectangles represent invoking operations like “SIP.getDestination” 406 that will call a getDestination on a SIP service. Two alternative ways of storing results may then be employed, i.e., the data can be stored implicitly or explicitly. In the case where the data is stored explicitly, the data can be stored in a format such as, for example, by List=SIP.getPresence. In the case where the data is implicitly stored, e.g., SIP.getDestination 406, the implementer 208 can generate a temporary variable in the generated code and use the variable in the subsequent invoke. Logic test constructs, represented by a diamond, in this example will first call the operation “getFirst” 408. The returned value is then checked. If the returned value is null, e.g., zero, a SIP 404 message (user not found) is sent back to the FindMe caller. If the returned value is a SIP address, an operation invite is invoked on SIP to establish a session between the caller and this first returned SIP address. A multiple choice construct, e.g., a switch, is a construct which allows testing of multiple values, i.e., a multiple choice construct is a generalized version of the logic test construct. The third type of construct, the End construct, allows the implementer 208 to generate code that releases temporary variables. While not used in the FindMe 402 example, according to exemplary embodiments, other constructs can be use, e.g., parallel constructs, loops, timers and other visual language extensions.

Using the service composition example Findme 402, an onInvite operation is executed when a SIP INVITE message is received. With this composed service, one can, for example, retrieve presence list information from a presence web service and then call, e.g., send a SIP INVITE, various online devices one after the other if a SIP response is not established. While not shown in FIG. 4, the Findme 402 composed service can be modified to include other options, such as, user preferences which are stored in a home subscriber service (not shown). These preferences could include information regarding when the online device is to be called, e.g., at only certain times, or the order of devices to call, e.g., mobile connection 112, work connection 114 and home connection 116.

According to exemplary embodiments, as described above, composed services can reuse other composed services (or operations) which can, in turn, shorten the deployment time of the newly composed service. FIG. 5 shows a new composed service TimedFindMe 502 which is a service recomposition example where the composed Findme 402 service is reused and composed with an HSS service (or other appropriate user database) that provides user preferences, as shown by the Findme.onInvite 404 operation. When used, before calling a user, e.g., an address, the current time is compared against the time period the current address is allowed to be called on as shown in the logical construct 504.

According to exemplary embodiments, the MSCF 200 can also use, as desired, other concepts and processes in support of service composition and/or the service composition architecture. For example, the service composition architecture can support all service creation life cycle phases and the interfaces provided are typically reusable. Also, the service composition architecture can manipulate similar types of entities uniformly. Additionally, real time services typically have constraints upon them in terms of response times, and service composition time (to aggregate code fragments together and have it validated), as well as other constraints as imposed by operator networks and physical limitations, therefore, the service composition architecture according to these exemplary embodiments can ensure that the composed services are within desired limitations in order to respect these constraints, e.g., ensure that composed services stay within known Quality of Service (QoS) requirements.

The exemplary embodiments described above provide methods and systems for composing services for converged networks using a multimedia service composition factory 200. Communications node 600 can contain a processor 602 (or multiple processor cores), memory 604, one or more secondary storage devices 606 and a communications interface 608. Communications node 600 is capable of processing instructions in support of performing the duties of any (or all) of the functions associated with the multimedia service composition factory 200. For example, in the role of the coordinator function, processor 602 can process the instructions required to push a composed service (which starts as a pre-compiled code segment from the IDE 202) through the other functions to result in a deployed composed service. As another example, the communications node 600 could include the functions of the designer, implementer and coordinator in a single location using various stored instructions and processor(s) to perform these functions, e.g., verifying syntax and compiling the final composed service.

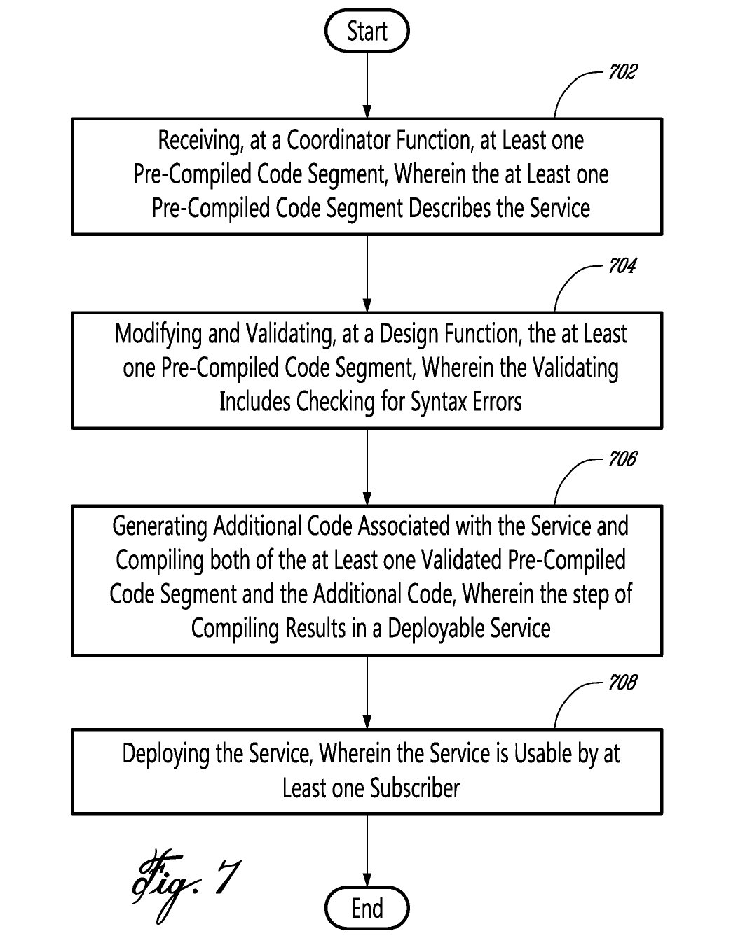

Utilizing the above-described exemplary systems according to exemplary embodiments, a method for composing a service is shown in the flowchart of FIG. 7. Initially a method for composing a service includes: receiving, at a coordinator function, at least one pre-compiled code segment, wherein the at least one pre-compiled code segment describes the service in step 702; modifying and validating, at a design function, the at least one pre-compiled code segment, wherein the validating includes checking for syntax errors in step 704; generating additional code associated with the service and compiling both of the at least one validated pre-compiled code segment and the additional code, wherein the step of compiling results in a deployable service in step 706; and deploying the service, wherein the service is usable by at least one subscriber in step 708.

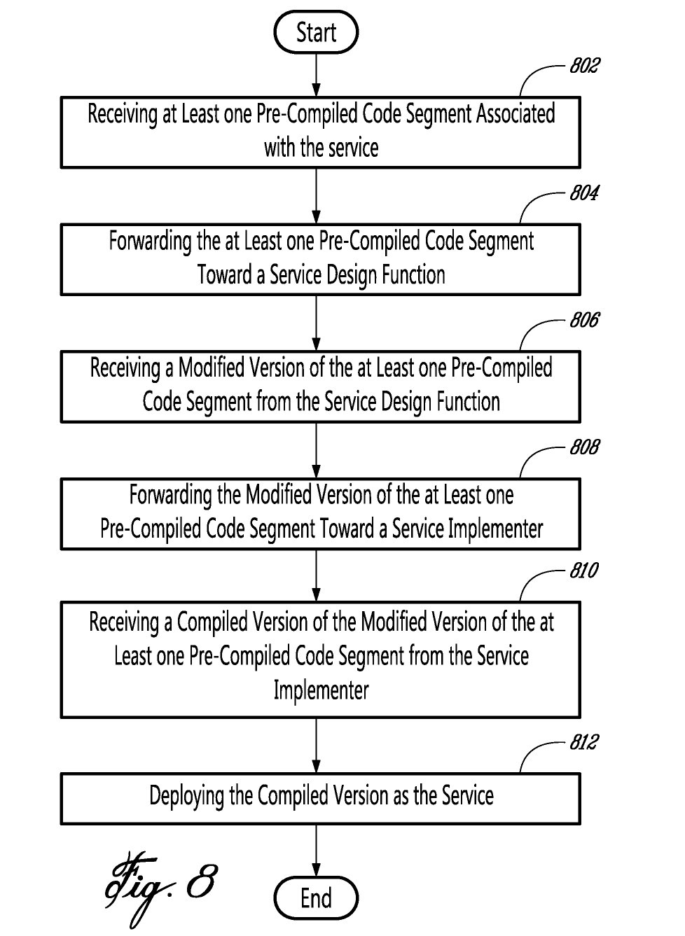

Utilizing the above-described exemplary systems according to exemplary embodiments, another method for composing a service is shown in the flowchart of FIG. 8. Initially a method for composing a service includes: receiving at least one pre-compiled code segment associated with the service in step 802; forwarding the at least one pre-compiled code segment toward a service design function in step 804; receiving a modified version of the at least one pre-compiled code segment from the service design function in step 806; forwarding the modified version of the at least one pre-compiled code segment toward a service implementer in step 808; receiving a compiled version of the modified version of the at least one pre-compiled code segment from the service implementer in step 810; and deploying the compiled version as the service in step 812.

As also will be appreciated by one skilled in the art, the exemplary embodiments may be embodied in, for example, a computing arrangement, a server, a wireless communication device, a telecommunication network, as a method or in a computer program product. Accordingly, the exemplary embodiments may take the form of an entirely hardware embodiment, an embodiment combining hardware and software aspects, or a purely software embodiment. Further, the exemplary embodiments may take the form of a computer program product stored on a computer-readable storage medium having computer-readable instructions embodied in the medium. Any suitable computer readable medium may be utilized including hard disks, CD-ROMs, digital versatile disc (DVD), optical storage devices, or magnetic storage devices such a floppy disk or magnetic tape. Other non-limiting examples of computer readable media include flash-type memories or other known memories.

Although the features and elements of the present exemplary embodiments are described in the embodiments in particular combinations, each feature or element can be used alone without the other features and elements of the embodiments or in various combinations with or without other features and elements disclosed herein. The methods or flow charts provided in the present application may be implemented in a computer program, software, or firmware tangibly embodied in a computer-readable storage medium for execution by a general purpose computer or a processor.

The above-described exemplary embodiments are intended to be illustrative in all respects, rather than restrictive, of the present invention. Thus the present invention is capable of many variations in detailed implementation that can be derived from the description contained herein by a person skilled in the art. All such variations and modifications are considered to be within the scope and spirit of the present invention as defined by the following claims. For example, the GUI associated with the IDE 202 could be web based allowing access from a web browser. No element, act, or instruction used in the description of the present application should be construed as critical or essential to the invention unless explicitly described as such. Also, as used herein, the article “a” is intended to include one or more items.

What is claimed is:

1. A method for composing a service comprising:
receiving, at a coordinator function, at least one pre-compiled code segment, wherein said at least one pre-compiled code segment describes said service;
modifying and validating, at a design function, said at least one pre-compiled code segment, wherein said validating includes checking for syntax errors;
generating additional code associated with said service and compiling both of said at least one validated pre-compiled code segment and said additional code, wherein said step of compiling results in a deployable service; and
deploying said service, wherein said service is usable by at least one subscriber.

2. A method for coordinating composition of a service comprising:
receiving at least one pre-compiled code segment associated with said service;
forwarding said at least one pre-compiled code segment toward a service design function;
receiving a modified version of said at least one pre-compiled code segment from said service design function;
forwarding said modified version of said at least one pre-compiled code segment toward a service implementer;
receiving a compiled version of said modified version of said at least one pre-compiled code segment from said service implementer; and
deploying said compiled version as said service.

3. The method of claim 2, wherein said service design function performs the steps of:
checking syntax of said at least one pre-compiled code segment; and
selectively modifying said at least one pre-compiled code segment.

4. The method of claim 2, wherein said service implementer performs the steps of:
generating code for said modified version of said at least one pre-compiled code segment;
verifying that said generated code is not in conflict with other associated code; and
compiling said generated code.

5. The method of claim 4, wherein said code includes previously generated code, further wherein said code is reusable for other deployable outputs.

6. The method of claim 5, wherein said compiled code is at least one of Java and C++.

7. The method of claim 2, wherein said at least one pre-compiled code template is associated with a pre-defined visual construct.

8. The method of claim 2, further comprising:
verifying said compiled version to ensure that said compiled version will not interfere with previously deployed services.

9. The method of claim 8, further comprising:
communicating with a database which stores dependency information in support of said verification.

10. The method of claim 2, further comprising:
installing said compiled version on at least one communications node.

11. The method of claim 2, further comprising:
activating said compiled version for at least one subscriber.

12. The method of claim 2, further comprising:
selecting an operation to invoke based at least upon said compiled version and said subscriber.

13. The method of claim 12, wherein said operation is a protocol translation.

14. The method of claim 13, wherein said protocol translation is from Simple Object Access Protocol (SOAP) to Session Initiation Protocol (SIP).

15. The method of claim 13, wherein said protocol is from Simple Object Access Protocol (SOAP) to Hyper-text Transport Protocol (HTTP).

16. The method of claim 2, wherein said service is a Findme service.

17. A system for coordinating composition of a service comprising:
a processor for coordinating steps associated with composing a service, said processor being configured to operate in accordance with one or more function modules; and
a coordinator function module for transmitting and receiving a composed service in various stages of said composed service's life cycle;
wherein, during said composed service's life cycle, said coordinator function module receives at least one pre-compiled code segment, receives and transmits a modified version of said at least one pre-compiled code segment from a service design function module, receives and transmits a compiled version of said modified version of said at least one precompiled code segment from a service implementer function module and deploys said compiled version as said service.

18. The system of claim 17, wherein syntax of said at least one pre-compiled code segment is checked and said at least one pre-compiled code segment is selectively modified by said service design function module.

19. The system of claim 17, wherein code is generated for said modified version of said at least one pre-compiled code segment, verified such that said generated code is not in conflict with other associated code; and said generated code is compiled by said service implementer function module.

20. The system of claim 19, wherein said code includes previously generated code, further wherein said code is reusable for other deployable outputs.

21. The system of claim 20, wherein said compiled code is at least one of Java and C++.

22. The system of claim 17, wherein said at least one pre-compiled code template is associated with a pre-defined visual construct.

23. The system of claim 17, wherein said compiled version is verified to ensure that said compiled version will not interfere with previously deployed services.

24. The system of claim 23, wherein a database which stores dependency information is communicated with in support of said verification.

25. The system of claim 17, wherein said compiled version is installed on at least one communications node.

26. The system of claim 17, wherein said compiled version is activated for at least one subscriber.

27. The system of claim 17, wherein an operation to invoke based at least upon said compiled version and said subscriber is selected.

28. The system of claim 27, wherein said operation is a protocol translation.

29. The system of claim 28, wherein said protocol translation is from Simple Object Access Protocol (SOAP) to Session Initiation Protocol (SIP).

30. The system of claim 28, wherein said protocol is from Simple Object Access Protocol (SOAP) to Hyper-text Transport Protocol (HTTP).

31. The system of claim 18, wherein said service is a Findme service.
